(19) United States
(12) Patent Application Publication
(10) Pub. No.: US 2008/0204280 A1
(43) Pub. Date: Aug. 28, 2008

(54) Methods and systems for airport runway lighting and communications

(75) Inventors: Richard E. Reason, Woodland Park, CO (US); Darren Kaberna, Woodland Park, CO (US)

Correspondence Address: POTOMAC PATENT GROUP PLLC, P. O. BOX 270, FREDERICKSBURG, VA, 22404, US

(73) Assignee: Bright Ideaz, Inc., Woodland Park, CO (US)

(21) Appl. No.: 11/712,124

(22) Filed: Feb. 28, 2007

(51) Int. Cl. B64F 1/18

(52) U.S. Cl. 340/955

(57) ABSTRACT

Systems and methods according to the exemplary embodiments provide techniques for illuminating airport travel paths, e.g., runways, taxiways, ground vehicle access paths, etc., and to use the illumination to communicate with pilots, aircraft and ground personnel. Different colors of light, which may be generated by lasers, are used in various combinations and in reaction to various inputs.

### BACKGROUND

The present invention describes methods and systems for using lasers to improve safety, communications and visibility in a variety of applications such as airport operations.

Airport operations are a complex interaction involving many variables including men, machines, and the elements. Interactions between these variables can occur in many forms. Airports have planes landing and taking off. The pilots of these planes interact with people in a control tower for instructions regarding landing, takeoff and taxiing. During these interactions, additional activities are typically occurring. For example, while talking to a tower operator, the pilot could be reading information from a variety of instruments and taking in visual cues from the environment outside of the cockpit of the plane. The tower personnel could be working with multiple people and/or aircraft. Other peripheral activities could be occurring in the area as well, including other planes taxiing, landing or taking off, and ground vehicular traffic. Additional hazards can come in the form of inclement weather such as rain or fog. Combined these activities and occurrences create a very complex, and potentially dangerous, environment. Accordingly, safety improvements are an important issue and a variety of safety measurements exist. One such safety measurement used to track the dangers of this environment is the quantity of runway incursions.

Runway incursions are defined, as found at http://www.faa.gov/runwaysafety as of Jan. 31, 2007, as “any occurrence in the airport runway environment involving an aircraft, vehicle, person, or object on the ground that creates a collision hazard or results in a loss of required separation with an aircraft taking off, intending to take off, landing, or intending to land”. The quantity of runway incursions is currently numbered in the hundreds per year amount. Combining the potential seriousness of this issue, with the volume of recorded runway incursions per year and the expected increases in air traffic as global population expands, it can be seen that improving the safety of airport operations is needed. One area of particular interest is in lighting and communication schemes for airports.

Using a flashlight as an example of ordinary light, when a person turns on a flashlight a light is generated that diffuses as it emanates out of the flashlight as directed by the flashlight's housing 102 as shown in FIG. 1(a). This light 104 can include different wavelengths of light that are diffused, or not in phase with each other, and produces a white light. A laser 106 on the other hand as shown in FIG. 1(b), produces a single wavelength (which defines the light color), wherein all of the waves are in phase and travel in the same direction. This provides a light 108 of a single color that is significantly more powerful than the ordinary light of a flashlight (assuming similar power supplies are used). A laser light is coherent, collimated, and monochromatic which allows for many uses for a laser light.

Since a laser light is more powerful and focused than an ordinary light, new uses for light sources have been introduced. Laser lights can be used for accurate range finding as well as for increasing light visibility in poor visibility environments. For example, laser lights can be more useful than an ordinary light in a potentially particulate laden environment such as a rainy, snowy or foggy area. For more examples on similar uses of a laser light, the interested reader is directed to U.S. Pat. No. 6,527,416 B1, filed on Sep. 18, 2000, entitled “Laser Indicator Having Rounded Lens to Widen a Laser Beam”, to Richard E. Reason et al. the disclosure of which is incorporated here by reference.

Some uses of lasers in combination with airport operations for safety improvements are already being considered. For example, reference is made to U.S. Pat. No. 6,320,516 B1 filed on Mar. 20, 2000, entitled “Airport and Runway Laser Lighting Method”, to Richard E. Reason and U.S. Pat. No. 6,688,755 B2, filed on Aug. 24, 2001, entitled “Laser Lighting System”, the latter of which uses laser lighting to improve runway/taxiway illumination as well as for showing preferred approach and departure routes. However, many more improvements in airport operations can be made using lasers, and other devices, for a variety of tasks. Accordingly, it would be desirable to provide methods and systems which address these issues.

### SUMMARY

According to one exemplary embodiment, a method for illuminating a runway to communicate with an airplane includes the steps of illuminating the runway with light having a first color, the first color indicating that the runway is clear for use, detecting an incursion to the runway, and changing, responsive to the detected incursion, the illumination of the runway to illuminate the runway with light having a second color different from the first color, the second color indicating that the runway is no longer clear for use.

According to another exemplary embodiment, a method for communication between a control tower and an airplane when voice communications have been lost includes the steps of illuminating a runway, on which the airplane has been assigned to land, using a light of a first color to communicate that landing on the runway for the airplane is cleared by the control tower, illuminating the runway using lights which flash the first color to communicate that landing on the runway is currently cleared, but clearance may be withdrawn by the control tower, illuminating the runway using lights which flash a second color, different than the first color, to communicate to the airplane that it should stop its approach and try again, and illuminating the runway using lights of the second color, if the control tower wants to instruct the airplane to halt its approach.

According to another exemplary embodiment, a method for illuminating runways of an airport includes the steps of illuminating a first runway with a first color light, illuminating a second runway with a second color light different than the first color light, and illuminating a third runway with a third color light different than the first color and the second color.

According to yet another exemplary embodiment, a method for controlling airport ground lighting from an airplane includes the steps of sending a signal from the airplane, receiving the signal by a device in communication with the airport ground lighting, and turning on a runway's lights in a first color based upon the signal.

According to still another exemplary embodiment, a device for detecting runway incursions includes a sensing device for detecting the incursions to a travel path in an airport and a monitoring device in communications with the sensing device for monitoring the sensing device and sending out an alert if the sensing device is triggered.

According to another exemplary embodiment, a method for uniquely identifying aircraft control towers within a predetermined geographical area includes the steps of assigning a first plurality of identifying colored lights to an aircraft control tower, wherein the light is laser light, and assigning a different plurality of identifying colored lights to each aircraft control tower within the predetermined geographical area, wherein the light is laser light.

According to another exemplary embodiment, a runway illumination system includes a laser illumination unit placed proximate an edge of a runway for generating at least one beam of laser light which travels in a path which is substantially parallel to the edge of the runway, at least one reflector placed proximate the edge of the runway for receiving and redirecting the beam of laser light along another edge of the runway, and a termination device of receiving and terminating the beam of laser light.

### BRIEF DESCRIPTION OF THE DRAWINGS

The accompanying drawings illustrate exemplary embodiments of the present invention, wherein:

FIG. 1(a) illustrates the light emanation from a flashlight;

FIG. 1(b) illustrates the light emanation from a laser;

FIG. 2 shows a laser used for illumination according to exemplary embodiments;

FIG. 3 illustrates using a bank of two lasers according to exemplary embodiments;

FIG. 4 depicts an airport ground layout according to exemplary embodiments;

FIG. 5(a) shows the intersection of a runway and a vehicle path with a laser circuit according to exemplary embodiments;

FIG. 5(b) shows the intersection of a runway and a vehicle path with a vehicle breaking a laser circuit according to exemplary embodiments;

FIGS. 6-9 are flowcharts illustrating methods of illuminating airport travel paths and using the illumination to communicate with aircraft, pilots and ground personnel according to exemplary embodiments;

FIGS. 10-14(b) illustrate various systems and methods whereby laser light can be used to illuminate edges of, or create light barriers across, travel paths of an airport according to exemplary embodiments; and

FIGS. 15(a) and 15(b) illustrate techniques and devices for redirecting a laser light beam to address runway discontinuities according to exemplary embodiments.

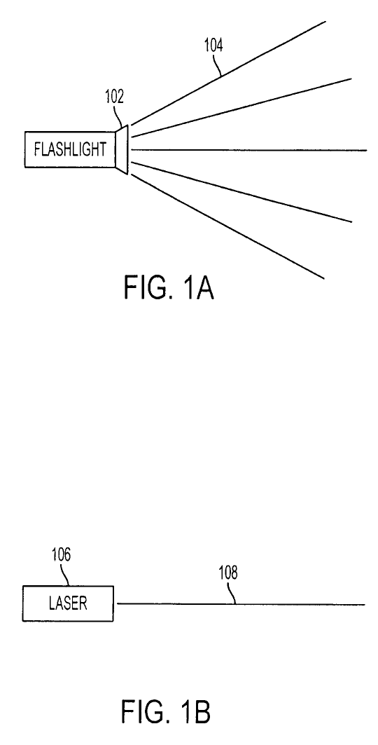

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

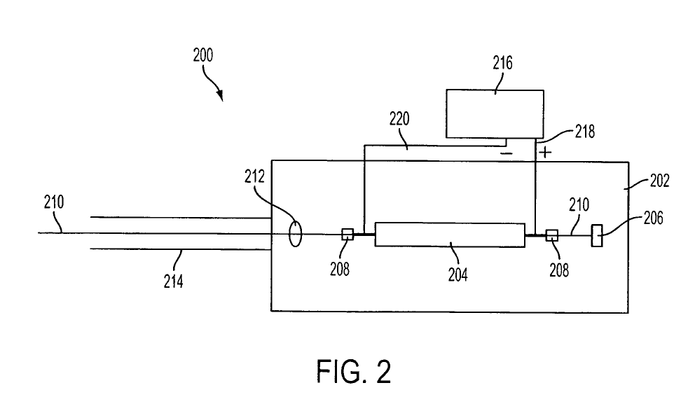

In order to provide some context for this discussion, an exemplary laser system 200 which can be used by the present invention will first be described with respect to FIG. 2. The basic components of an argon laser system 200 can be seen in FIG. 2. The laser housing 202 contains plasma tube 204, reflecting mirror 206, angle windows 208, and partially transmissive mirror 212. Power supply 216 has two power leads (218 and 220) which are connected to plasma tube 204 for exciting the ions (not shown) in the Argon gas within the tube. These ions bounce between the two mirrors 206 and 212 becoming laser light beam 210. Depending upon the amount of power used by the laser system 200, a protective housing 214 can be attached to the laser system 200 for protection. For example if a 40 watt laser is used, then a housing 214 of 6-8 feet in length might be appropriate. In this way, nothing will cross the laser light beam 210 before its power is reduced to a safe amount.

The typical argon laser has two wavelengths that are more pronounced. One of these wavelengths emits green light, and the other wavelength emits blue light. Filters can be used as desired to determine what wavelengths of light are emitted. Different exemplary embodiments described later in the specification could use a different type of laser as would be understood by one skilled in the art to achieve either a different color of light, or for a lower powered implementation.

A variety of methods exist for powering the exemplary laser system. The laser system can be hooked into the airport's currently existing power grid. Alternatively, a generator can be used, which can be particularly useful for a mobile or portable laser illumination system. Alternatively, solar panels, wind generators and batteries can be used alone or in combination to provide, or assist in providing, power to the laser system.

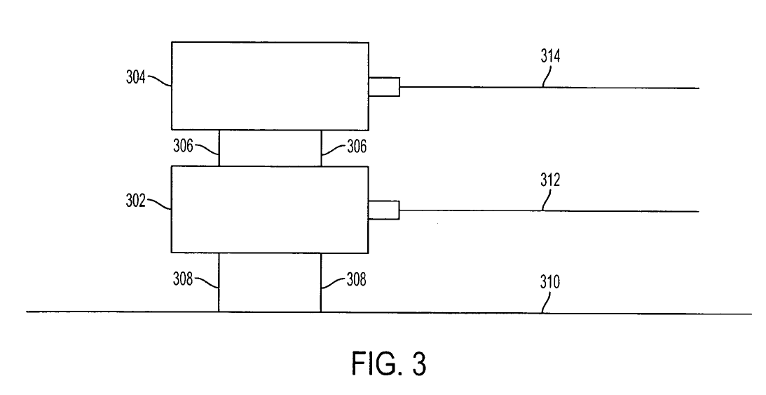

For many of the exemplary embodiments described within this specification there is a need to have multiple colors of laser lights being used at a variety of times. According to one exemplary embodiment, banks of lasers that emit different wavelengths of light are used and mounted in proximity with each other as shown in FIG. 3. FIG. 3 contains laser unit 1 (302) whit laser unit 2 (304) mounted on top. Laser unit 2 (304) contains legs 306 and emits laser light beam 2 (314). Laser unit 1 (302) has legs 308 resting upon the ground 310, and emits laser light beam 1 (312). While in FIG. 3 both light beams are depicted, it is to be understood that in most embodiments only one laser will be emitting at a time. These lasers shown in FIG. 3 are depicted as being in a vertical arrangement, however other layout arrangements are also possible.

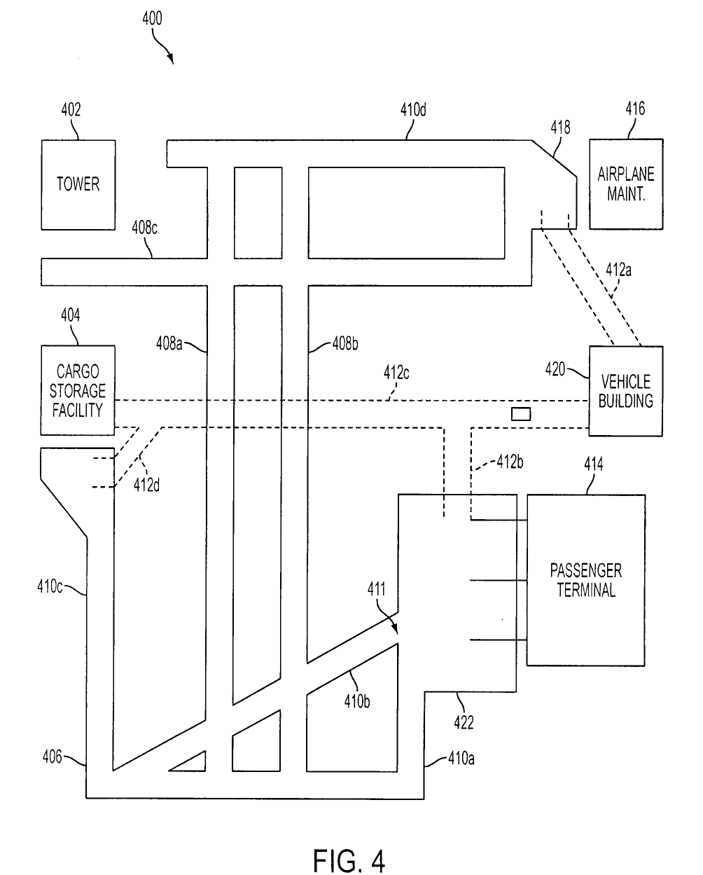

Regardless of the specific type(s) of lasers or laser systems employed, exemplary embodiments of the present invention employ such lasers and laser systems to perform various purposes at airports. Accordingly, it is useful, as context, to understand basic elements of interest at an airport. FIG. 4 shows an exemplary airport layout 400 which depicts airport elements that will use exemplary laser systems as described below. Exemplary airport 400 contains a control tower 402, a cargo storage facility 404, an airplane traffic zone 406 (which further comprises runways 408a, 408b, 408c, taxiways 410a, 410b, 410c, 410d, airplane maintenance area 418, passenger loading area 422 and cargo loading area 424), vehicle traffic lanes 412a, 412b, 412c, 412d, a passenger terminal 414, an airplane maintenance building 416 and a vehicle building 420. Additional elements exist within airport 400 including airplanes, vehicles, lighting devices and communication devices which will be shown and described in more detail below. It is to be appreciated that the airport 400 in FIG. 4 could contain other structures and more of the items shown such as runways, taxiways and ground traffic lanes and that the present invention is not limited to the exemplary airport layout shown in FIG. 4, but could instead be used at any airport regardless of its specific layout.

As described in the Background section, lasers are useful in low visibility environments such as smoke, fog, snow, ice, rain or when other particulates are in the air. Lasers can be useful in these low visibility environments because light emitted from a laser is more powerful than ordinary light since it is collimated, coherent and monochromatic. The laser light (or energy wave) when emitted from a laser is not visible until the light comes into contact with a particle. The amount of light seen by an observer (assuming no obstructions between the observer and the contact point) is primarily based upon density of the impacted particle(s), the power of the laser, distance of the observer from the point of contact, interfering or unfocused light sources and density of particles in the air between the observer and the contact point. Thus using a laser light instead of an ordinary light source would increase the distance from which the contact point of light to a particle would be seen by an observer because the strength of the laser light is stronger and more focused. Additionally, the wavelength of the laser light can be chosen in order to emit a specific color of light which can be useful in reducing interference from other light sources and for other purposes described below.

According to one exemplary embodiment, laser lights can be used to illuminate the areas where a plane is expected to travel while on the ground. These laser lights (in conjunction with reflectors as needed) can be used to illuminate the edges of runways, taxiways or other appropriate sections of the airport to more effectively guide the pilot. Different colors of laser lights can be used to identify different routes for the plane to traverse. For example, referring again to FIG. 4, suppose that a plane is to go from passenger loading area 422 to runway 408a. Initially, the plane heads for taxiway 410a which is illuminated with a blue laser light along the edges thereof indicating that taxiway 410a is cleared for use. Taxiway 410b is illuminated along its edges with a red laser light indicating to the pilot to not travel upon taxiway 410b. Alternatively, or in addition to illuminating the edges of runway 410b with a “do not traverse” color (in this example), a sheet of red laser light could be projected across the opening 411 between taxiway 410b and passenger loading area 422 rendering it difficult for a pilot to use the wrong taxiway as the plane would have to pass through the sheet of red laser light to enter the (wrong) taxiway. As an alternative to a sheet of light, a focused laser beam can be reflected back and forth across an area to create another type of light barrier. As the plane taxis down taxiway 410a the plane will pass by runway 408b which can also be illuminated with another red laser light indicating to the pilot to not travel upon runway 408b. Runway 408a is illuminated with blue laser light indicating that it is the correct runway for takeoff. In this example, blue laser light was used as the light for permissible travel areas, and red laser light was used to indicate areas that were off limits to a particular aircraft. It is to be understood that any combination of laser light colors can be used to indicate travel lanes and do not travel lanes. These laser lights can be associated with either a plane, or the type of travel area or some combination thereof. Additionally, laser lights can be used to project the desired takeoff or landing path. Alternatively other types of light sources or combinations thereof can be used.

According to another exemplary embodiment, as described above using laser lights for illuminating airplane travel areas, laser lights can be used for illuminating other travel lanes at an airport. For example, vehicular traffic and people traffic can have designated travel lanes that are illuminated with laser lights. For example in FIG. 4 the vehicular travel lanes 412a-412d can be illuminated along one or more edges with a green laser light to assist in keeping the vehicles in the appropriate travel lanes and other traffic out of the lane. Other colors of laser light can be used as desired.

In the previous exemplary embodiments, laser lights were used to illuminate travel paths for both airplanes and ground vehicle traffic. These lighting schemes can be manually controlled or controlled by a more automated method. For manual control, the ability to turn on or off an illuminating laser light could reside in the tower 402 and be turned on as desired by an operator. Laser light color switching, or turning on and off of different lasers within a bank, could be done all at once for less complex transit paths, or done in stages for more complex travel paths. For example, if a plane needs to transit past or on multiple runways and taxiways, after passing by each runway/taxiway or using each runway/taxiway the lasers could be turned off or reset for the next plane.

In a more automated exemplary system, an operator would interact with the system to either initiate the process or provide key information. For example, suppose that a plane is ready to leave the passenger loading area 422. The plane's transit path is known by the system. The system is notified that a plane has finished loading all passengers and finished the appropriate actions and is ready to begin taxiing. This notification can come in a variety of methods, such as a command from the plane or a key entry from an operator in the tower. This notification then starts a process whereby the system illuminates the travel path for the indicated plane through the appropriate taxiways to the correct runway. This illuminated path can stay in place until the plane takes off, or be deactivated as the plane passes predetermined locations along the illuminated path, e.g., using a motion sensor, ground radar, GPS, or the like to determine the plane's current location relative to areas which have been predetermined to result in deactivation of illumination. The system could be informed that the plane has passed the appropriate spots, by methods such as pressure switches, light beam breakage, distance based on planes individual radio signal, operator entry or received radio command and turn off the appropriate illumination.

According to another exemplary embodiment, different colors can be persistently associated with different runways. For example, runway 408c could be named “runway 28 blue” and have blue laser lights illuminating it, and runway 408b could be named “runway 34 green” and have green laser lights illuminating it. This matching of colored laser lights to specific runways would be provide another safety feature to assist the pilot in landing on the correct runway at the correct airport. Additionally, this idea can be carried over such that traffic lanes for vehicles can have their own unique identifying color(s).

According to another exemplary embodiment, laser lights such as those illustrated in FIGS. 2 and 3 are placed at various locations within the exemplary airport 400 to provide the above-described, and other, airport illumination and communication functions. As will be described subsequently, laser units and optical elements for directing and terminating laser beams generated by the laser units can, for example, be placed proximate edges of travel paths for airplanes and/or ground vehicles, as well as placed across from each other relative to a travel path to generate a light barrier.

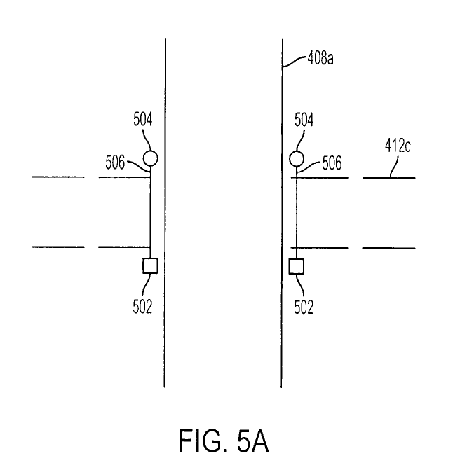

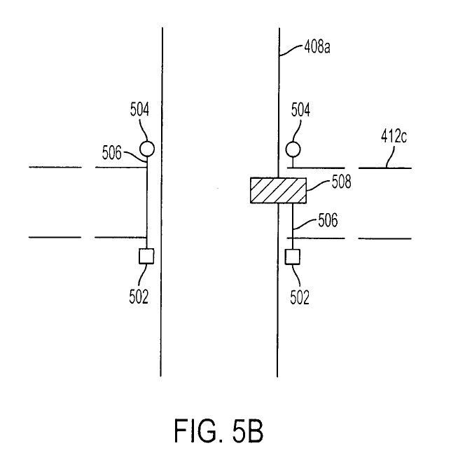

As described in the Background section, runway incursion is a safety measure used to describe “any occurrence in the airport runway environment involving an aircraft, vehicle, person, or object on the ground that creates a collision hazard or results in a loss of required separation with an aircraft taking off, intending to take off, landing, or intending to land”. Lasers can be used according to these exemplary embodiments to reduce the quantity and the severity of runway incursions. According to another exemplary embodiment, a laser transmits a beam that is received by a sensor directly across from the laser at the desired distance. This beam creates a line or a non-solid barrier separating two spaces, e.g., the afore-described entryway 411 between taxiway 410b and passenger loading area 422, with the system of emitter, beam and sensor creating a circuit. If the beam is interrupted, or if either the sensor fails or the emitter ceases to operate, the circuit can be considered to be broken. Devices can be used in conjunction with this circuit for monitoring purposes and for producing an alert when the circuit is broken. An exemplary method of using this circuit will now be explained with respect to FIGS. 4, 5(a) and 5(b).

Consider that a plane (not shown) is preparing to use runway 408a which is illuminated by blue laser light. Additionally, a non-solid laser light barrier exists, created by another laser emitting along the edge of runway 408a at a predetermined vertical distance above the ground where vehicle traffic lane 412c crosses the runway. As shown in FIG. 5(a) a laser beam 506 is transmitted by laser emitter 502 and is received by a sensor 504 directly in line with the emitter 502 on the opposite side of vehicle traffic lane 412c (or alternatively an infrared transmitter/detector combination or the like). Since a plane is preparing to take off, there should be no vehicles in vehicle traffic lane 412 where the lane crosses runway 408a. In FIG. 5(a) the circuit is not broken and operations can proceed normally for takeoff. In FIG. 5(b) an incursion has occurred wherein a vehicle has broken the circuit. This can be seen where vehicle 508 stops the emitted beam 506 from reaching sensor 504. When this circuit is broken an alert can be sent out leading to a variety of responses. One exemplary response would have the light which illuminates runway 408a switch from a blue laser light to a red laser light indicating that runway 408a is not currently safe for use. Upon clearing of the incursion the switch can be reset either manually or automatically which in turn would switch the laser light illuminating runway 408a from red back to blue. According to another exemplary embodiment, instead of using a laser sensing circuit to detect incursions associated with intersecting airport paths, other sensing means can be used such as a pressure switch in communication with a monitoring device or an infrared (IR) monitoring device such as those used in conjunction with garage doors. Additionally, this concept can be used for detecting if a plane has left an area that it should not have left, or crossed over into a vehicular or pedestrian traffic area. The vertical distance above ground for the location of the laser circuit or other sensing circuit can be fixed or variable depending upon the expected traffic type and preferably set to a mid-range of vehicle heights.

According to another exemplary embodiment a plane can control the lighting of portions of an airport. For example, referring again to FIG. 4, suppose that a plane is coming in to land on runway 408b. When a plane is at some predetermined distance from the runway and on its approach, lighting illumination for runway 408b triggers on to a predetermined color indicative of a clear runway. The lighting for runway 408b can be triggered by a variety of methods, such as, receiving a signal, determining distance from the plane based on the plane's individual radio signal or a trigger initiated by the pilot. Once the lighting for runway 408b is triggered on, the lighting for taxiway 410b would be changed to, e.g., red indicating that no planes should transit down that taxiway. Alternatively, when the plane attempts to trigger runway 408b to turn on the illuminating lights and either there is an incursion onto runway 408b or taxiway 410b is in use, the illuminating lights could flash red to warn the plane not to make its final approach. Also the illuminating lights for runway 408b could turn to the appropriate landing color when the incursion or issue has been cleared and it is safe for the plane to land. Likewise, this exemplary embodiment can be used for a plane that is in the process of taking off. For example, upon taking off the illuminating lights will turn off (or change colors to indicate that the runway is no longer cleared for use) on the runway and the taxiways that cross the runway can have their respective lasers changed to provide a lighting scheme which means that the taxiways are clear for traffic.

According to another exemplary embodiment when a plane loses communications with a tower, a backup communication process can be provided where the tower uses a colored spotlight(s) to communicate with a plane. Using the exemplary laser light illumination systems described above, the laser light being used to illuminate a runway could be used to communicate with a plane that is not in voice communications with a tower. Instead of flashing the colored spotlight(s), colored sets of laser lights can be used. These lights would preferably already be in place on the designated runway, e.g., as described above to designate the runway as clear or not clear, however mobile or portable systems could be used as needed. An operator in the tower could then flash the appropriate color in the appropriate pattern on the runway itself for communicating with the plane. This method allows for both identifying the correct runway for landing, and for communicating with the plane while reducing or eliminating the need for the pilot to observe both the runway and the tower. This process can also be used if multiple inbound aircraft have lost voice communications with the tower. Additionally, this process can be automated and can be implemented when planes have voice communications with the tower as a supplemental identification means for the pilot.

According to another exemplary embodiment airports are also identified by a color scheme of lights shown on a tower. These lights are typically ordinary lights, but in exemplary embodiments can be laser lights. Laser lights allow for more power (longer sight distance) and for a simple method for creating more unique colors to allow for easier identification of an airport. Since the color of a laser is based upon its wavelength, it is relatively easy to preset the color of the laser light. This can be extremely useful in an area where a number of airports are relatively close together because each airport could have its own unique tower color scheme.

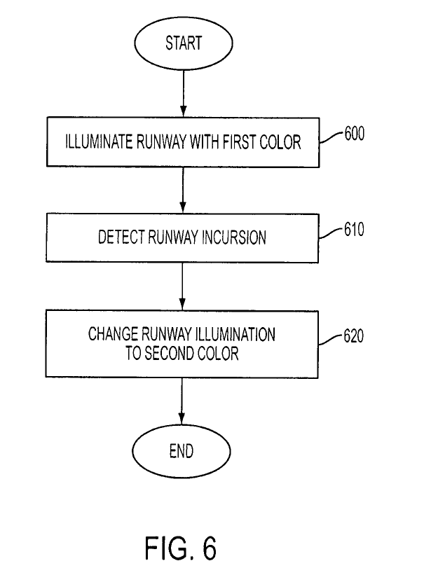

It will be appreciated based on the foregoing that exemplary embodiments of the present invention thus provide techniques for illuminating various areas in airports in various manners which provide various information to aircraft and aircraft pilots and ground personnel that will facilitate safe takeoffs, landings and other movements around airports. According to one exemplary embodiment, a method for illuminating a runway to communicate with an airplane is illustrated in the flowchart of FIG. 6. This method includes the step of illuminating the runway with light having a first color at step 600. This first color can be selected to indicate that the runway is clear for use. Next, at step 610, an incursion to the runway is detected. In response thereto, the illumination of the runway is changed to illuminate the runway with light having a second color different from the first color, the second color indicating that the runway is no longer clear for use (step 620).

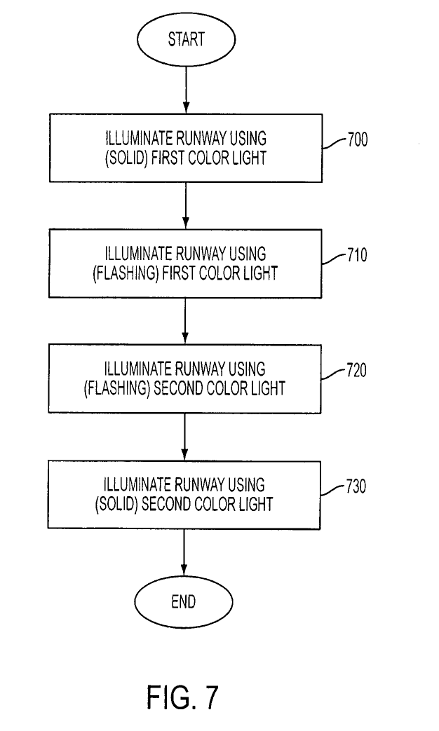

According to another exemplary embodiment, a method for communication between a control tower and an airplane when voice communications have been lost is illustrated in the flowchart of FIG. 7. This method includes the step 700 of illuminating a runway, on which the airplane has been assigned to land, using a light of a first color to communicate that landing on the runway for the airplane is cleared by the control tower. The communication method can also illuminate the runway using lights which flash the first color to communicate that landing on the runway is currently cleared, but clearance may be withdrawn by the control tower at step 710. Further, the method includes the step 720 of illuminating the runway using lights which flash a second color, different than the first color, to communicate to the airplane that it should stop its approach and try again. Moreover, the method provides for illuminating the runway using lights of the second color, if the control tower wants to instruct the airplane to halt its approach a step 730.

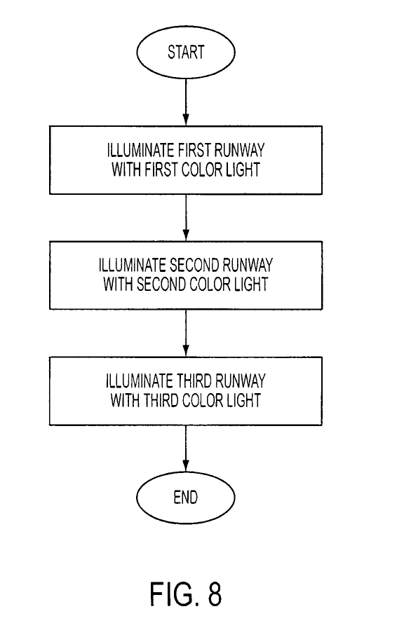

According to still another exemplary embodiment, a method for illuminating runways of an airport provides for assigning runways with different color codes via illumination as shown in the flowchart of FIG. 8. Thus, a first runway is illuminated with a first color light at step 800. A second runway is illuminated with a second color light different than the first color light at step 810. A third runway is illuminated with a third color light different than the first color and the second color at step 820.

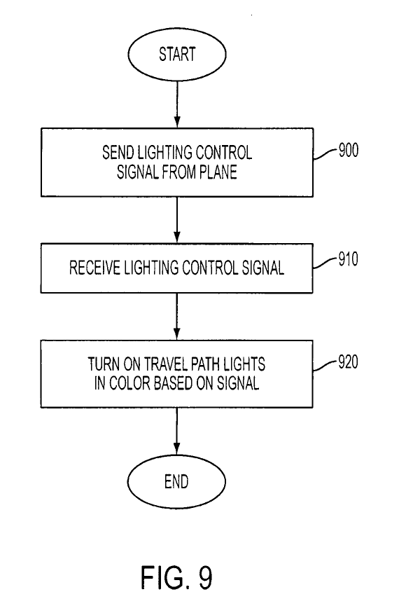

According to yet another exemplary embodiment, a method for airport ground lighting can be controlled from an airplane. An exemplary method is shown in the flowchart of FIG. 9, and includes the step 900 of sending a signal from the airplane. This signal is received by a device in communication with the airport ground lighting (step 910), and results in turning on a runway's lights in a first color based upon the signal (step 920).

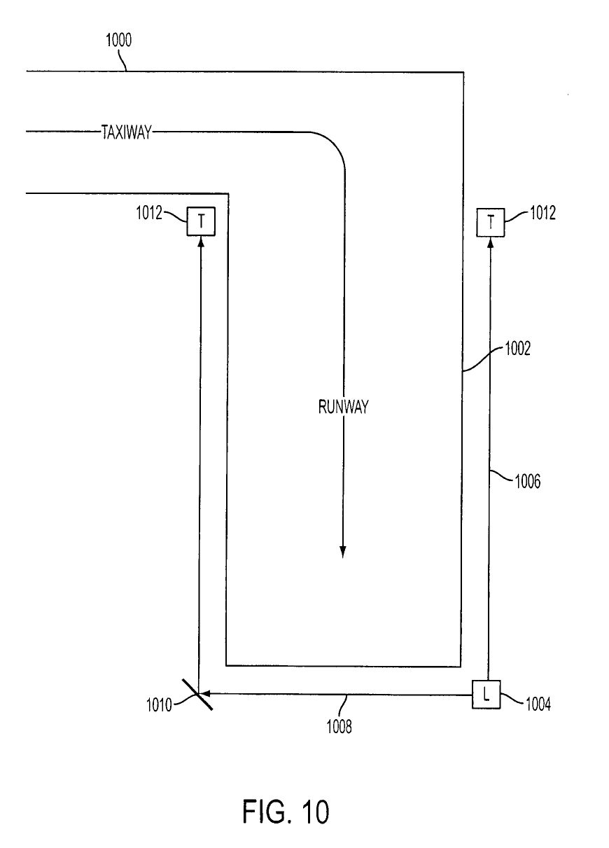

According to one exemplary embodiment, laser light illumination of a runway can be provided as shown in FIG. 10. Therein, a taxiway 1000 is connected to a runway 1002 such that a plane using the taxiway 1000 and runway 1002 for takeoff would travel in the direction of the arrow illustrate in the center of the travel path. A laser or bank of lasers L 1004, e.g., as described above, is used to provide the illumination for the edge of the runway 1000. In this exemplary embodiment, two beams of laser light are output from the unit 1004. A first beam of light 1006 is output parallel (or substantially parallel) to one side of the runway 1002, while a second beam of light 1008 is output parallel (or substantially parallel) to an end of the runway 1002. The two beams of light 1006 and 1008 can be generated by a single laser by splitting the beam inside the unit 1004 using an optical splitter. The beam of light 1008 can be reflected by reflector 1010 disposed across the runway 1002 from the laser unit 1004 such that it then travels along the other side of the runway 1002, i.e., parallel to beam 1006. The reflector 1010 can, for example, be a mirror or any other reflector suitable for laser light. At some point along the runway 1002, termination posts 1012 can be provided on both sides to terminate the light beams 1006 and 1008. The termination posts 1012 can, for example, include beam traps fabricated as a metallic tube having cone-shaped baffles, to trap the incident laser beams safely and stop them from continuing past the termination posts 1012.

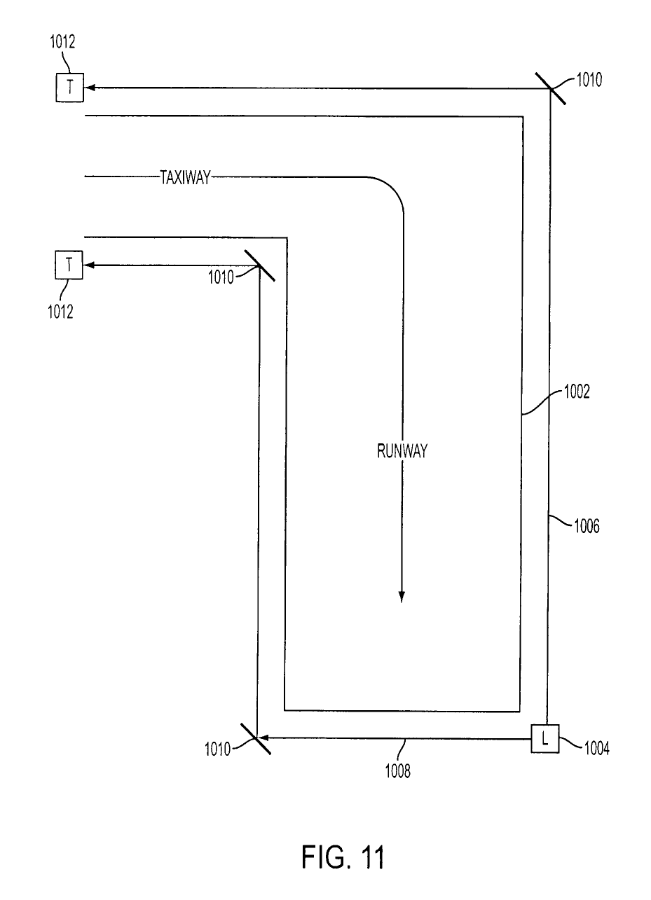

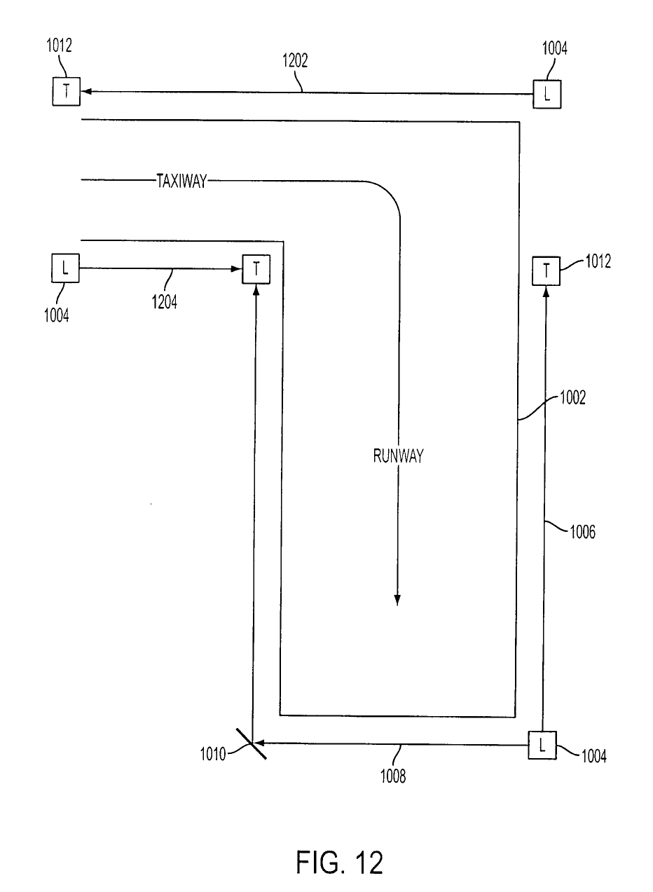

As will be appreciated based on the foregoing discussion, the beams of laser light 1006 and 1008 can be generated using one of a plurality of different wavelengths such that the color of the light is selectable, e.g., based on a command signal from a control tower (not shown). As mentioned earlier, the ability to generate different color laser lights from the unit 1004 can be provided in a number of different ways, e.g., using a plurality of different lasers each of which output laser light of a different color (wavelength) or using a laser whose wavelength is selectable. The selected color can convey, e.g., to a landing airplane, information as discussed previously. Although not shown in FIG. 10, the taxiway 1000 can also be illuminated using laser light of the same color (or a different color) as that used to illuminate the runway 1002. If it is intended that the same color laser light be used to illuminate the taxiway 1000 and the runway 1002, then the same laser unit 1004 may be used to provide illumination to the taxiway 1004 by moving the termination posts 1012 to the ends of the taxiway 1000 and providing additional reflectors 1010 to guide the light around the perimeter of the taxiway. This latter, exemplary configuration is illustrated as FIG. 11. Alternatively, another set of elements including a laser unit 1004, reflector(s) 1010 and termination posts 1012 can be added to what is shown in FIG. 10 to illuminate the taxiway 1000 as shown in FIG. 12. Therein, additional laser light beams 1202 and 1204 illuminate the edges of the taxiway I 000 leading to runway 1002. This latter alternative enables the taxiway 1000 to be illuminated using a different color laser light than runway 1002, if desired.

Another consideration is the height at which the laser beams are generated relative to the ground/runway. To avoid potential blockages of the beams, e.g., caused by snow or the like, it may be desirable to elevate the beams from the ground. According to exemplary embodiments, this elevation may be in the range of 1-10 feet and, more specifically, elevations of 3, 4, 5 and 6 feet may provide a good compromise between beam blockage avoidance and good illumination of the travel paths, although the present invention is not limited to any of these specific elevations.

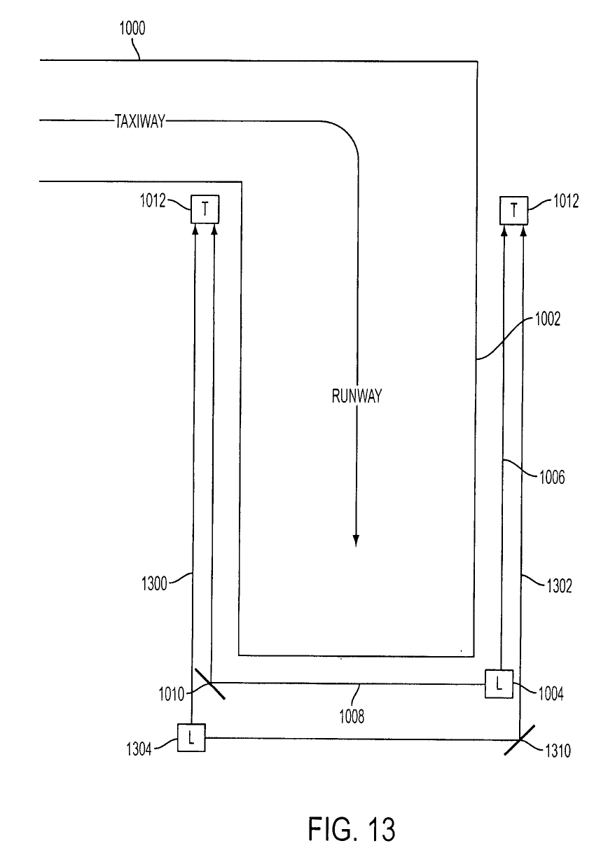

Yet another consideration is laser redundancy. In order to ensure high availability of the runway illumination and communication systems and methods according to these exemplary embodiments, it may be desirable to provide additional lasers and light beams as redundancy. For example, referring to the exemplary embodiment of FIG. 13, it may be desirable to add a second system of laser illumination elements 1304 and 1310 to generate a second pair of beams 1300 and 1302 to illuminate the runway 1002. The second laser unit 1304 can operate simultaneously with unit 1004 or can be switched in immediately if laser unit 1004 fails to facilitate continuous illumination of the runway 1002.

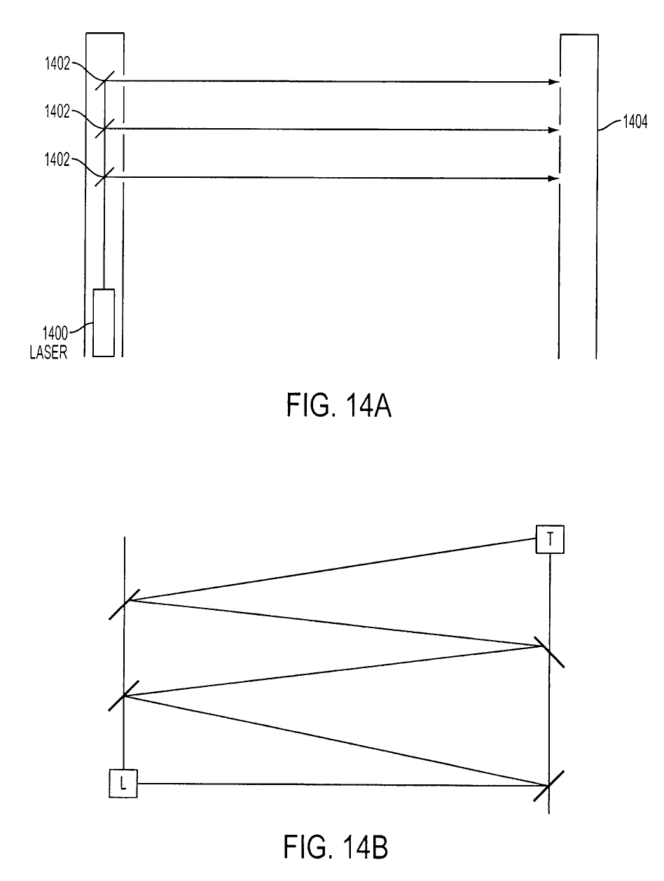

As also mentioned above, in addition to illuminating the edges of runways, taxiways or other travel paths in an airport, it may also (or alternatively) be desirable to provide illumination across portions of travel paths, e.g., those portions which an airplane or ground vehicle should not traverse. This can be accomplished in a variety of ways. According to one exemplary embodiment, illustrated in FIG. 14(a), a laser fence can be provided on opposite sides of a travel path which provides one or more light “rails” across the travel path. As shown in this purely illustrative Figure, a laser 1400 can be partially reflected and partially transmitted through a series of optical elements 1402 to split and redirect the light across the desired portion of a travel path to create a light barrier which informs a pilot or other individual that they should not pass through. The beams can be trapped on the opposite side of the travel path using, e.g., a termination post 1404 as described above. The light barrier can take any desired shape, e.g., an “X” or a zigzag pattern using a series of reflectors attached to supports as shown in FIG. 14(b). Preferably the one or more laser beams which create the light barrier are provided at a height which is lower than cockpit level of the smallest plane using the airport, but high enough to be visible by larger planes using the airport.

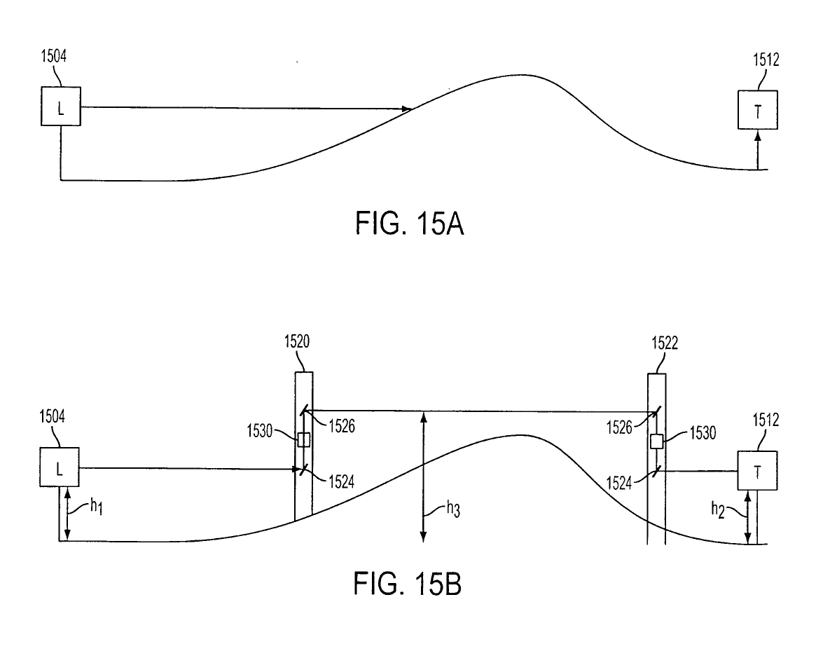

According to yet another exemplary embodiment, it is appreciated that runways and other travel paths in airports may not be completely level. In fact, given the length of runways and other travel paths, it is likely that they will not be level and may have other discontinuities, e.g., bumps. Such discontinuities may block the light generated by a laser unit 1504 as shown in FIG. 15(a). Accordingly, in order to provide complete edge illumination it may be necessary to add redirection mechanisms to provide additional elevation to the laser light along one or more portions of an edge of a travel path. For example, as shown in FIG. 15(b), a first redirection mechanism 1520 receives an incident laser light beam and redirects it from a first elevation h1 to a second elevation h3 so that it avoids a discontinuity in the runway (and/or the region proximate the runway over which the beam travels). The redirection mechanism 1520 includes a pair of reflectors 1524 and 1526 as well as an optional optical processing element 1530 which, for example, re-collimates the laser beam. Another redirection mechanism 1522 can be provided to bring the beam back down to a lower elevation (h2 which may be the same or different than h1) after it has traversed the discontinuity. Alternatively, the second redirection mechanism 1522 could be omitted and the light beam could travel the remainder of the travel path at the height h3 prior to hitting the termination post 1512. It will be appreciated that an edge of a travel path and or an illumination system according to these exemplary embodiments may include a plurality of redirection mechanisms (or none) as needed to address the particular conditions.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments describe, among other things, the use of laser light, many of the foregoing exemplary embodiments can be performed using infrared light, different spectrums of visible laser light and ordinary light. Additionally, different scopes of implementation of the above exemplary embodiments would be used depending upon other factors such as airport size and traffic volume. These exemplary embodiments could also be used for cargo and military aircraft/airport operation. Moreover, if a runway or taxiway that is being illuminated is not level, then laser banks according to exemplary embodiments can re-collimate and re-direct the beam appropriately. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for illuminating a runway to communicate with an airplane comprising:
illuminating said runway with light having a first color, said first color indicating that said runway is clear for use;
detecting an incursion to said runway; and
changing, responsive to said detected incursion, said illumination of said runway to illuminate said runway with light having a second color different from said first color, said second color indicating that said runway is no longer clear for use.

2. The method of claim 1, further comprising:
providing a plurality of banks of lasers proximate boundaries of said runway, each of said banks of lasers having at least a first laser for outputting laser light of said first color and a second laser for outputting laser light of said second color.

3. The method of claim 1, wherein said first color is green and said second color is red.

4. The method of claim 1, wherein said step of illuminating further comprises illuminating at least one edge of a runway.

5. The method of claim 1, further comprising reflecting said light using a reflector.

6. The method of claim 2, wherein said banks of lasers are powered by at least one of: an electrical connection to an existing power grid, battery power, solar power, wind power and a generator.

7. The method of claim 1, wherein said step of detecting further comprises:
detecting, by way of a sensor, that a vehicle has entered, or is about to enter, said runway.

8. The method of claim 7, wherein said sensor is one of a pressure switch and an optical sensor.

9. The method of claim 1, further comprising
illuminating another portion of a travel path for said aircraft, with said light of said first color; and
turning off a portion of said illumination of said travel path after said aircraft has traveled through said portion.

10. The method of claim 9, wherein said portion of said illumination of said travel path is turned off either manually or automatically.

11. The method of claim 10, further comprising determining that said aircraft has traveled through said portion of said travel path using at least one of: a pressure switch activated by said aircraft, optical sensing of said aircraft and a radio signal emitted from said aircraft.

12. A method for communication between a control tower and an airplane when voice communications have been lost comprising:
illuminating a runway, on which the airplane has been assigned to land, using a light of a first color to communicate that landing on said runway for said airplane is cleared by said control tower;
illuminating said runway using lights which flash said first color to communicate that landing on said runway is currently cleared, but clearance may be withdrawn by said control tower;
illuminating said runway using lights which flash a second color, different than said first color, to communicate to said airplane that it should stop its approach and try again; and
illuminating said runway using lights of said second color, if said control tower wants to instruct said airplane to halt its approach.

13. The method of claim 12, wherein said first color is green and said second color is red.

14. The method of claim 12, wherein said light is generated by lasers.

15. A method for illuminating runways of an airport comprising the steps of:
illuminating a first runway with a first color light;
illuminating a second runway with a second color light different than said first color light; and
illuminating a third runway with a third color light different than said first color and said second color.

16. The method of claim 15 further comprising:
communicating to an airplane a color associated with a runway to which it has been assigned to land or take off from.

17. A method for controlling airport ground lighting from an airplane comprising:
sending a signal from said airplane;
receiving said signal by a device in communication with said airport ground lighting; and
turning on a runway's lights in a first color based upon said signal.

18. The method of claim 17, further comprising turning on lights for other travel paths in a second color based upon said signal.

19. A device for detecting runway incursions comprising:
a sensing device for detecting said incursions to a travel path in an airport; and
a monitoring device in communications with said sensing device for monitoring said sensing device and sending out an alert if said sensing device is triggered.

20. The device of claim 19, wherein said sensing device further comprises:
an emitting laser, wherein said emitting laser emits a light beam; and
a receiving sensor opposite of said emitting laser which receives said beam.

21. The device of claim 20, wherein said sensing device is triggered when said receiving sensor does not receive said light beam from said emitting laser.

22. The device of claim 19, wherein said alert triggers a change in runway illumination lighting.

23. The device of claim 19, wherein said alert notifies a control tower operator of said runway incursion.

24. The device of claim 19, wherein said sensor is a pressure switch.

25. A method for uniquely identifying aircraft control towers within a predetermined geographical area comprising:
assigning a first plurality of identifying colored lights to an aircraft control tower, wherein said light is laser light; and
assigning a different plurality of identifying colored lights to each aircraft control tower within said predetermined geographical area, wherein said light is laser light.

26. The method of claim 2, wherein each of said plurality of banks of lasers further include a housing within which said laser light is housed for a predetermined distance after being output from a respective laser.

27. The method of claim 26, wherein said predetermined distance is 6-8 feet.

28. The method of claim 2, wherein if a runway or taxiway that is being illuminated is not level, then said plurality of laser bank can re-collimate and re-direct the laser light.

29. A runway illumination system comprising:
a laser illumination unit placed proximate an edge of a runway for generating at least one beam of laser light which travels in a path which is substantially parallel to said edge of said runway;
at least one reflector placed proximate said edge of said runway for receiving and redirecting said beam of laser light along another edge of said runway; and
a termination device of receiving and terminating said beam of laser light.

30. The runway illumination system of claim 29, wherein said beam of laser light is spaced vertically from ground by a predetermined distance.

31. The runway illumination system of claim 30, wherein said predetermined distance is 1-10 feet.

32. The runway illumination system of claim 31, wherein said predetermined distance is one of: three, four, five and six feet.

33. The runway illumination system of claim 29 further comprising:
a redirection mechanism for changing an elevation of said beam of laser light disposed between said laser illumination unit and said termination device.
